(19) United States
(12) Patent Application Publication
(10) Pub. No.: US 2011/0210594 A1
(43) Pub. Date: Sep. 1, 2011

(54) HEADREST ATTACHMENT

(75) Inventor: Jonas EISENBRAUN, Russelsheim (DE)

(73) Assignee: GM GLOBAL TECHNOLOGY OPERATIONS, INC., Detroit, MI (US)

(21) Appl. No.: 12/883,799

(22) Filed: Sep. 16, 2010

(30) Foreign Application Priority Data
Mar. 1, 2010 (DE) 202010002968.6

(51) Int. Cl. B60N 2/48

(52) U.S. Cl. 297/391

(57) ABSTRACT

A headrest attachment is provided for attaching a headrest brace to a vehicle seat structure, with a sheath for accommodating the headrest brace, a flexible, axial latching device and a radial support for fixation to the vehicle seat structure. The radial support is functionally decoupled from the flexible axial latching device.

### CROSS-REFERENCE TO RELATED APPLICATION

This application claims priority to German Patent Application No. 202010002968.6, filed Mar. 1, 2010, which is incorporated herein by reference in its entirety.

### TECHNICAL FIELD

The present invention relates to a headrest attachment for securing a headrest brace to a vehicle seat structure, as well as to a vehicle with such a headrest attachment.

### BACKGROUND

Known from DE 199 19 335 B4 and CN 2010 99 191 are headrest attachments in the form of multipart sheaths, which are provided for attachment to a vehicle seat frame, and accommodate a headrest brace in an axially shiftable manner, so as to guide and fix the latter in the vehicle frame. The headrest attachments are inserted from above into a corresponding receptacle of the vehicle seat frame, until a screwed stop in the form of one or more radial steps abuts the receptacle. CN 2010 99 191 provides a flexible clip for axially latching the inserted headrest attachment, securing it against being pulled out against the direction of insertion. The known headrest attachments are supported against the receptacle of the vehicle seat frame in a radial direction by a radially flexible element, for example the flexible clip in CN 2010 99 191.

This integration of axial latching and radial support function can advantageously offset manufacturing tolerances in a radial direction between the sheath and the receptacle that accommodates it, and reduces the production related expenses. On the other hand, this radial flexibility allows a pitching motion of the headrest relative to the seat frame. Studies have now revealed that these pitching motions lead to a poor performance of the headrest system, in particular during a sudden acceleration in the longitudinal direction of the vehicle in response to a collision from the front or rear.

Therefore, at least one object of the present invention is to achieve an improved headrest performance. In addition, other objects, desirable features, and characteristics will become apparent from the subsequent summary and detailed description, and the appended claims, taken in conjunction with the accompanying drawings and this background.

### SUMMARY

A headrest attachment according to an embodiment of the invention generally exhibits a sheath for accommodating one or more headrest braces. In particular, a sheath is here understood to be a one- or multipart base unit, preferably plastic, with any, preferably at least essentially cylindrical, outer contour, and at least one blind or through hole for accommodating a headrest brace. Such a hole can be closed or interrupted around its circumference, in particular exhibit openings in a jacket surface of the sheath. The headrest attachment preferably has an integrated or separate axial fixing means for a headrest brace, for example in the form of a torsion spring.

The headrest attachment further has a flexible axial latching device to detachably or non-detachably secure it against being pulled out of the vehicle seat structure, which in a preferred embodiment has one or more flexible clips that can move radially against the sheath and, when entirely or partially spring-extended, form an extraction stop to limit or prevent the headrest attachment from axially moving out of a receptacle of the vehicle seat structure that partially or completely envelops the sheath in a circumferential direction. To limit an insertion motion into such a receptacle, the flexible axial latching device can have a radial step to form an insertion stop.

In this way, the headrest attachment can be inserted into a corresponding receptacle of the seat structure as the flexible axial latching device deforms, in particular the clip(s). Before or as it reaches a jointing position that is preferably defined in an axial direction by the insertion stop, the axial latching device is spring-extended in a radial direction under complete or partial recovery, thereby preventing the headrest attachment from being pulled out of the seat structure against the direction of insertion. An insertion and extraction stop can here in particular be axially spaced apart and designed in such a way as to limit an axial movement of the headrest attachment relative to the seat structure within a certain clearance, or prevent it entirely with no clearance. In particular, due to the flexibility of the axial latching device, an axial distance between the insertion and extraction stop can correspond to or be slightly less than an axial length of the receptacle of the seat structure accommodated between them, so as to prestress the headrest attachment in an axial direction.

A headrest attachment according to an embodiment of the invention also has a radial support to radially detachably or non-detachably to the seat structure, preferably with at most a slight clearance, more preferably without any clearance, and especially preferably elastically prestressed. In particular, the radial support can encompass one or more radial, in particular axially or longitudinally ribbed projections, for abutment against a receptacle of the vehicle seat structure.

Two or more projections are here preferably distributed over the periphery of the sheath in such a way, for example at least essentially equidistantly, that the projections in this receptacle abut the seat structure once the sheath has been introduced into the latter. The diameter of a circle circumscribing the radial faces of the abutting projections is preferably equal to or slightly greater than the inner diameter of the receptacle accommodating the sheath, so that the inserted sheath is elastically or plastically stressed in the receptacle via the projections, and thereby also frictionally counteracts a movement in the circumferential or axial direction. The radial support preferably has one or more pairs of radial projections, which essentially are diametrically opposed, wherein one or more projections are most advantageously aligned in essentially the longitudinal direction of the vehicle once installed, so as to reduce a pitching motion by the headrest during acceleration in the traveling direction. Additionally or alternatively, one or more projections can be aligned at least essentially in the transverse direction of the vehicle once installed, so as to reduce a rolling motion of the headrest during accelerations transverse to the traveling direction.

The radial support is functionally decoupled from the flexible axial latching device. In this way, the headrest attachment is supported against the vehicle structure in a radial direction, for example in the longitudinal and/or transverse direction of the vehicle, without interspersing the elasticity of the axial latching device, and so can be secured thereto more rigidly, in particular making it possible to reduce or avoid the impaired performance of the headrest system found in studies during a sudden acceleration in the longitudinal or transverse direction of the vehicle in response to a collision from the front, rear or side.

For example, in a preferred embodiment described above, in which the radial support is provided using correspondingly dimensioned and arranged longitudinal ribs, the latter prevent a headrest brace exposed to greater deformation of a clip that must be correspondingly flexible in design for purposes of axial insertion from pitching or rolling in a radial direction, i.e., tilting in a receptacle of the vehicle seat structure.

Another advantage arises in relation to an insertion or extraction actuation of the headrest brace in the headrest attachment. During the axial insertion or extraction of the headrest brace, if ergonomics dictate that it also be pulled or pushed in a radial direction against the headrest attachment, this no longer triggers a friction-enhancing support against the flexible clip, since such a radial drawing in or pressing out is directly supported on the seat structure via the radial projections.

The radial support, in particular one or more ribs or projections, and/or the flexible axial latching device, in particular a flexible clip and/or an insertion stop, can each be molded entirely or partially integral with the sheath, in particular with one made out of plastic. This not only reduces the manufacturing and installation outlay, but also hedges against the loss of individual components.

To this end, one of more flexible clips can each be defined by a bilateral axial and possibly unilateral slit in the circumferential direction in the jacket surface of the sheath. In particular in this type of configuration, it can be advantageous to arrange one or more radial projections in the circumferential direction next to a flexible clip, so as to take over the radial support in this area in place of the flexible clip. For this purpose, such radial projections are preferably designed in such a way that they protrude forward in a radial direction relative to the flexible clip at least in its latched state, thereby taking over the function of providing full radial support.

The radial projections are preferably designed in such a way with the headrest attachment installed as to create a radial clearance between a flexible clip and a receptacle or seat structure that accommodates the headrest attachment.

In terms of the embodiments of the present invention, a vehicle seat structure is to be construed in particular as a frame that is at least partially encased by a cladding made of fabric, leather, artificial leather or the like, and preferably made out of metal or plastic. However, it can likewise take the form of a seat shell or the like.

### BRIEF DESCRIPTION OF THE DRAWINGS

The present invention will hereinafter be described in conjunction with the following drawing figures, wherein like numerals denote like elements, and:

FIG. 1 a headrest attachment according to an embodiment of the present invention, lateral partial section;

FIG. 2 the headrest attachment of FIG. 1, top view; and

FIG. 3 a cross section along the III-III line on FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

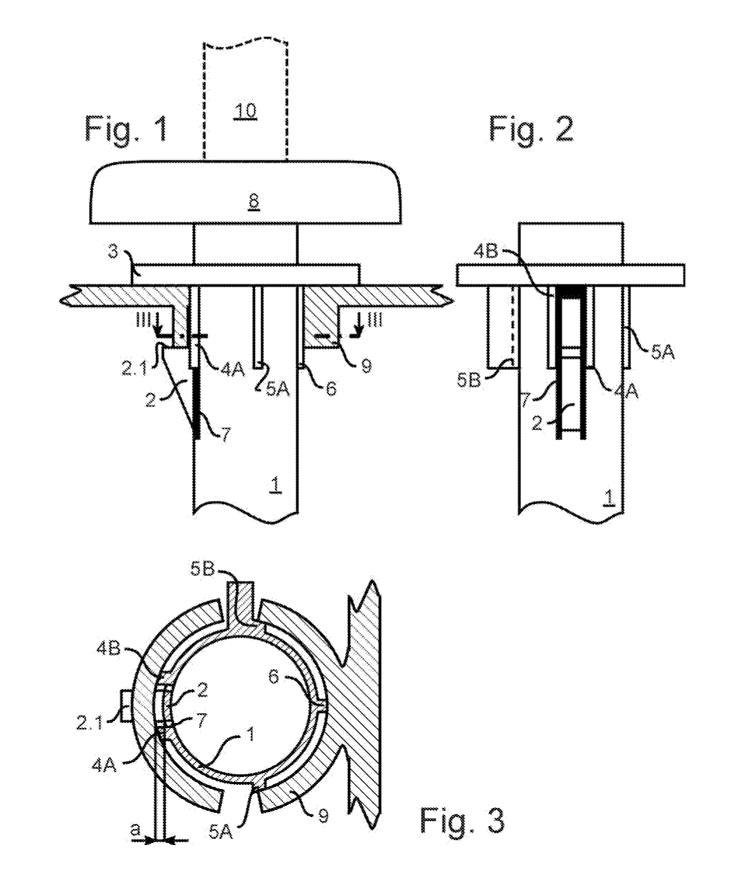

On FIG. 1, a sheath-like headrest attachment 1 with a cover 8 according to an embodiment of the present invention is inserted from above into an annular holder 9 of a vehicle seat frame (not shown in any greater detail), so that a radial flange 3 lies atop the holder 9 as the insertion stop, preventing any further insertion.

Two axial slits 7 (compare FIG. 2) and a slit in the circumferential direction (top of FIG. 2) in the jacket surface of the sheath-like headrest attachment 1 define an elastic clip 2, which forms an extraction stop by way of a radial step 2.1 directed opposite the flange 3. On the axially opposing side, the clip 2 has a starting incline. During insertion into the annular holder 9 from above, the clip runs onto the starting incline on the inner circumference of the holder 9, moving radially inward flexibly against the sheath-like headrest attachment 1, and after reaching the jointing position shown on FIG. 1, snaps back outwardly in a radial direction into the non-deformed initial position, so that the sheath-like headrest attachment 1 with its flange 3 as the insertion stop and the clip 2 as the extraction stop 2.1 is latched in an axial direction with the holder 9.

In the circumferential direction laterally next to the slits 7, which define the clip 2, on the diametrically opposing side (right on FIG. 1, 3) as well as essentially at 90 offset thereto (top, bottom on FIG. 3), longitudinal ribs 4A, 4B, 5A, 5B or 6 are molded integrally onto the sheath-like headrest attachment 1. These support the sheath-like headrest attachment 1 in a radial direction (left to right on FIG. 1, 2) in the holder 9, and to this end extend radially in such a way as to abut from inside against the through hole in the holder 9, at least essentially free of clearance, or even exposed to a slight elastic or plastic compression. To this end, the diameter of a circle circumscribing the radial projections 4A to 6 corresponds to the inner diameter of the hole in this holder 9, or is slightly larger or smaller than the latter.

This circumscribed circle does not take into account a radial elongation of the rib 5B (left on FIG. 2; top on FIG. 3), since the latter acts as a torsion safeguard by engaging into a longitudinal slit resembling a continuous or blind hole in the annular holder 9, and limits a twisting of the sheath-like headrest attachment 1 in the holder 9 in the circumferential direction.

As evident in particular from FIG. 3, the ribs 4A, 4B arranged laterally next to the clip 2 project over the clip 2 in a radial direction by measure “a” in the radial attachment area of the holder 9, i.e., over the radial step of the clip 2 serving as the axial latching device, thereby ensuring a corresponding radial clearance “a” between the latched elastic clip 2 and the holder 9.

In this way, the sheath-like headrest attachment 1 or a headrest brace 10 inserted therein and denoted by a dashed line on FIG. 1 is not supported according to the invention in a radial direction in the seat structure via the clip 2 provided with a flexible design for insertion and latching purposes, but rather by the longitudinal ribs 4a to 6, in particular in place of the clip 2 via the ribs 4A, 4B situated laterally next to the latter, which prevents or reduces swinging by the headrest in the longitudinal direction of the vehicle (left to right on FIG. 1).

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A headrest attachment for attaching a headrest brace to a vehicle seat structure comprising:
a sheath adapted to accommodate the headrest brace;
a flexible axial latching device adapted for fixation on the vehicle seat structure; and
a radial support adapted for fixation on the vehicle seat structure and functionally decoupled from the flexible axial latching device.

2. The headrest attachment of claim 1, wherein the radial support comprises at least one radial projection for abutment against a holder of the vehicle seat structure.

3. The headrest attachment of claim 2, wherein the at least one radial projection is a ribbed projection

4. The headrest attachment of claim 2, wherein the radial support comprises at least one essentially opposing pair of radial projections for abutment against the holder of the vehicle seat structure.

5. The headrest attachment claim 1, wherein the flexible axial latching device comprises at least one clip that is flexible in a radial direction to form an extraction stop, and a radial step to form an insertion stop.

6. The headrest attachment of claim 1, wherein the radial support is designed at least partially integral with the sheath.

7. The headrest attachment of claim 1, wherein the flexible axial latching device is designed at least partially integral with the sheath.

8. The headrest attachment of claim 5, wherein the at least one clip is movable through an axial slit against the sheath in the radial direction.

9. The headrest attachment of claim 1, wherein at least one radial projection of the radial support is situate next to a flexible clip of the flexible axial latching device in a circumferential direction.

10. The headrest attachment of claim 9, wherein a radial projection arranged next to the flexible clip in the circumferential direction projects forward in a radial direction relative to the latter.

11. The headrest attachment of claim 1, wherein at least one radial projection of the radial support is designed in such a way that with the headrest attachment installed, a radial clearance is created between a flexible clip and a holder of the vehicle seat structure that accommodates the headrest attachment.

12. The headrest attachment of claim 1, further comprising a torsion safeguard relative to the vehicle seat structure.

13. A vehicle seat, comprising:
a vehicle seat structure;
a headrest attachable to the vehicle seat structure with a headrest brace comprising at least one headrest attachment, the at least one headrest attachment comprising:
a sheath adapted to accommodate the headrest brace;
a flexible axial latching device adapted for fixation on the vehicle seat structure; and
a radial support adapted for fixation on the vehicle seat structure and functionally decoupled from the flexible axial latching device.

14. The vehicle seat of claim 13, wherein the radial support comprises at least one radial projection for abutment against a holder of the vehicle seat structure.

15. The vehicle seat of claim 14, wherein the at least one radial projection is a ribbed projection.

16. The vehicle seat of claim 14, wherein the radial support comprises at least one essentially opposing pair of radial projections for abutment against the holder of the vehicle seat structure.

17. The vehicle seat of claim 13, wherein the flexible axial latching device comprises at least one clip that is flexible in a radial direction to form an extraction stop, and a radial step to form an insertion stop.

18. The vehicle seat of claim 13, wherein the radial support is designed at least partially integral with the sheath.

19. The vehicle seat of claim 13, wherein the flexible axial latching device is designed at least partially integral with the sheath.

20. The vehicle seat of claim 17, wherein the at least one clip is movable through an axial slit against the sheath in the radial direction.
